(19) United States
(12) Patent Application Publication
(10) Pub. No.: US 2008/0197156 A1
(43) Pub. Date: Aug. 21, 2008

(54) Keg Tap Adapter With Flow Restriction

(75) Inventors: Albert Wauters, Destelbergen (BE); Ian Anderson, Cambridge (GB)

Correspondence Address: Levy & Grandinetti, Suite 408, 1725 K Street N W, wASHINGTON, DC, 20006-1419, US

(73) Assignee: INBEV S.A., Leuven (BE)

(21) Appl. No.: 11/597,128

(22) PCT Filed: May 20, 2005
(86) PCT No.: PCT/IB2005/001381

§ 371 Date: Dec. 10, 2007

(30) Foreign Application Priority Data
May 20, 2004 (GB) 0411294.2

(51) Int. Cl. B67D 3/00

(52) U.S. Cl. 222/517

(57) ABSTRACT

A tap adapter (38) for use in dispensing an alcohol beverage from a container (22) has a shoulder (152), a support arm (150), a dispensing tube, a flow restricting actuator (200), and a switch (300). The dispensing tube is supported by the support arm and provides a beverage flow passageway for dispensing beverage from the container. The dispensing tube has at least a flexible wall portion (86). The flow restricting actuator is pivotally attached to the shoulder and moves between a first position remote of the dispensing tube and a second locked position to partially collapse the flexible wall portion and restrict flow of beverage through the passageway. The switch, when actuated by a user, releases the flow restricting actuator from the second locked position. The switch of the tap adapter facilitates disconnection of the dispensing tube from a spent container and the changing of the dispensing tube.

### FIELD OF THE INVENTION

The present invention relates to an alcohol beverage dispensing apparatus and in particular, relates to a tap adapter utilized to dispense the beverage.

### BACKGROUND OF THE INVENTION

It is known to contain alcohol, such as wine, in bags contained in a cardboard type container where the wine feeds by gravity through a shut off tap mounted outside the container. Further, it is known to fill a bag with beer in a keg. In the case of a beer keg, pressure is applied to the bag to dispense the beer from the bag and out of the keg. Further, the bag is inserted into the keg container prior to the beer being filled into the bag through a valve assembly.

However, there is a need for the user to be able to control the dispensing of the beer from the keg out through a tap connected to the valve assembly. In a home beverage dispensing system suitable for use in dispensing beer, the keg is a replaceable item and the tap is an item that forms part of a tap adapter that is mounted to the keg and controls the flow of beverage from the keg.

The tap adapter has an elongated tube that extends from a tap to a valve connected to the keg. The tube has a constant inner diameter through which the beverage flows. In order to insure that beverage flows from the keg out the adapter, the internal keg pressure may be higher than a preferred delivery pressure of the beverage. Should the beverage be delivered from the tap adapter at too high a pressure, excessive foaming of the beverage may occur. Accordingly, there is a need to control the delivery pressure of the beverage from the adapter so as not to introduce excessive foaming of the beverage as it is being dispensed from the tap. Further, because the user has to replace the keg in the home dispensing appliance, this results in the user having to remove the tap adapter from the spent keg and then attach the tap adapter to a new keg. At this time the user can replace or clean the dispensing tube of the tap adapter. Accordingly, any improvement is welcome that facilitates the connection and disconnection of the dispensing tube and tap adapter.

### SUMMARY OF THE INVENTION

It is desired to provide an adapter for dispensing a beverage which limits the dispense pressure of the beverage.

It is desired to provide a keg adapter having a dispensing tube for dispensing a beverage that is readily disconnected from a spend keg.

The present invention relates to a tap adapter for use in dispensing an alcohol beverage from a container. The tap adapter comprises a dispensing tube having a beverage flow passageway for dispensing beverage from the container. The dispensing tube has a flexible wall portion. The tap adapter further includes a flow restricting actuator adapted to engage the flexible wall portion of the dispensing tube to partially collapse the flexible wall portion. This partial collapse of the dispensing tube restricts the flow of beverage along the beverage flow passageway and thereby limits the dispense pressure of the beverage.

By partially collapsing the flexible wall portion the diameter of the beverage flow passageway is reduced to restrict the amount of beverage flowing through the dispensing tube. As a result, the delivery pressure of the beverage downstream of the flow restriction is reduced and thereby controls the flow rate of the beverage dispensed from the adapter.

By reference to the dispensing tube having at least a flexible wall portion, it is envisaged that the dispensing tube may comprise a series of tube portions some of which may not be flexible. Accordingly, it is an important aspect of the present invention that at least a portion of the tube be flexible so that when engaged by the flow restricting actuator, this portion of the tube may collapse thereby reducing or restricting beverage flow through the passageway. In one embodiment, the dispensing tube may be a continuous tube which is of uniform diameter and is flexible throughout its length. Thus, that portion of the flexible tube collapsing in response to engagement with the flow restricting actuator is referred to as the flexible wall portion in this embodiment.

In accordance with one aspect of the present invention a tap adapter for use in dispensing an alcohol beverage from a container has a shoulder and a support arm. The support arm has an elongate channel having a floor, a first side wall portion and a second side wall portion. The support arm has an access portion adjacent the second side wall portion. A dispensing tube is supported in the channel on the floor between the first and second side wall portions. The dispensing tube provides a beverage flow passageway for dispensing beverage from the container. The dispensing tube has at least a flexible wall portion. The tap adapter has a flow restricting actuator that is pivotally attached to the shoulder. The actuator is movable between a first position remote of the dispensing tube and a second position at least partially passing through the access portion of the support arm to squeeze the flexible wall portion between the first wall portion and the flow restricting actuator so as to partially collapse the flexible wall portion and restrict flow of beverage through the passageway. This tap adapter provides a unique structure that acts to limit the dispense pressure of the beverage.

In one embodiment, the flow restricting actuator comprises an elongate lever that extends adjacent the support arm and has a protrusion that is laterally movable through the access opening of the support arm to engage the flexible wall portion of the dispensing tube. The protrusion is adapted to slide over the floor of the channel and has a depending flange adapted to engage the support arm to limit displacement of the protrusion through the access opening so as to control the partial collapse of the flexible wall portion.

In accordance with another aspect of the present invention a tap adapter for use in dispensing an alcohol beverage from a container comprises a shoulder, a support arm, a dispensing tube, a flow restricting actuator, and a switch. The dispensing tube is supported by the support arm and provides a beverage flow passageway for dispensing beverage from the container. The dispensing tube has at least a flexible wall portion. The flow restricting actuator is pivotally attached to the shoulder and moves between a first position remote of the dispensing tube and a second locked position to partially collapse the flexible wall portion and restrict flow of beverage through the passageway. The switch, when actuated by a user, releases the flow restricting actuator from the second locked position.

In one embodiment it is envisaged that the switch is mounted with the shoulder and the switch, when actuated by a user, further disconnects the first end portion of the dispensing tube from a first valve of the keg. Further, when the switch is actuated, the flow restricting actuator retracts into its first position. The switch of the tap adapter facilitates disconnection of the dispensing tube from a spent container and the changing of the dispensing tube.

### BRIEF DESCRIPTION OF THE DRAWINGS

For a better understanding of the nature and objects of the present invention reference may be had to the accompanying diagrammatic drawings in which:

FIG. 1 is a front elevation view of a home beer dispensing apparatus in accordance with the present invention;

FIG. 2 is a side elevation view of the home beer dispensing apparatus;

FIG. 3 is a sectional side view of the valve and spear assembly within the keg;

FIGS. 4 to 6 are perspective views of the tap adapter showing the dispensing tube respectively being inserted, held in place and pivoted open; and,

FIGS. 7 to 9 are sectional views through the tap adapter respectively for FIGS. 4 to 6.

### DETAILED DESCRIPTION OF THE INVENTION

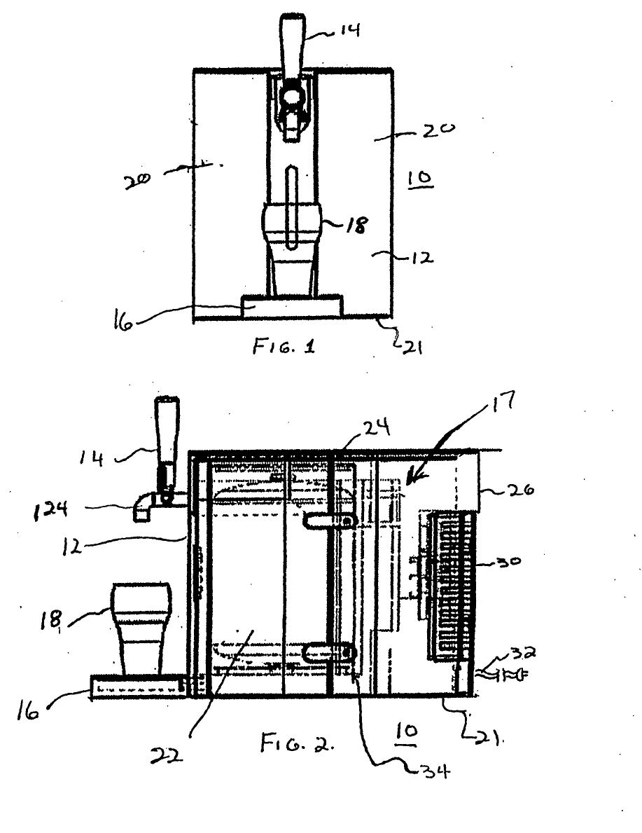

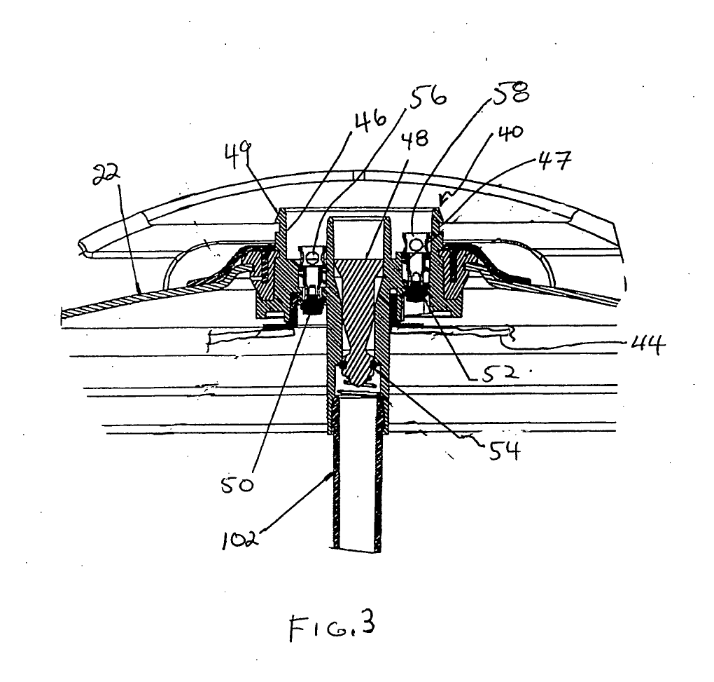

Referring to FIGS. 1 and 2 there is shown a home beer dispensing apparatus, appliance or unit 10. The dispensing apparatus 10 is primarily intended for use in domestic kitchens but may also be used in utility rooms, garages, domestic bars, caravans etc. While the preferred embodiment relates to dispensing beer, alternatively carbonated solutions or other alcohol beverages may be dispensed by apparatus 10.

The home beer dispensing apparatus 10 has a front wall 12 and a dispensing tap 14 protruding forward of the front wall 12. A drip tray 16 also protrudes forward of the front wall 12 and is adapted to support an open glass container 18 below the dispensing tap 14. The home beer dispensing apparatus 10 further has a base 21 adapted to rest on a counter top. The front wall 12 is an extension of two pivoting side walls 20 which may be moved between closed and open positions to allow the keg 22 (see FIG. 2 in broken lines) to be inserted into the housing of the home beer dispensing apparatus 10.

The housing 17 of the home beer dispensing apparatus 10 further includes a top wall 24 and a rear wall 26. The rear wall 26 has a grill 30 that permits for air circulation within the home beer dispensing apparatus 10. An electrical cord 32 extends through the rear wall 26 of the apparatus 10 to provide a connection into a main electrical supply to supply electrical power to the electrical components housed within the unit 10. Alternatively, a 12 Volt DC supply input may be used.

The dispensing apparatus 10 has a cooling system 34 located behind and below keg 22 that is adapted to cool beer in keg 22 when keg 22 is placed into dispensing apparatus 10

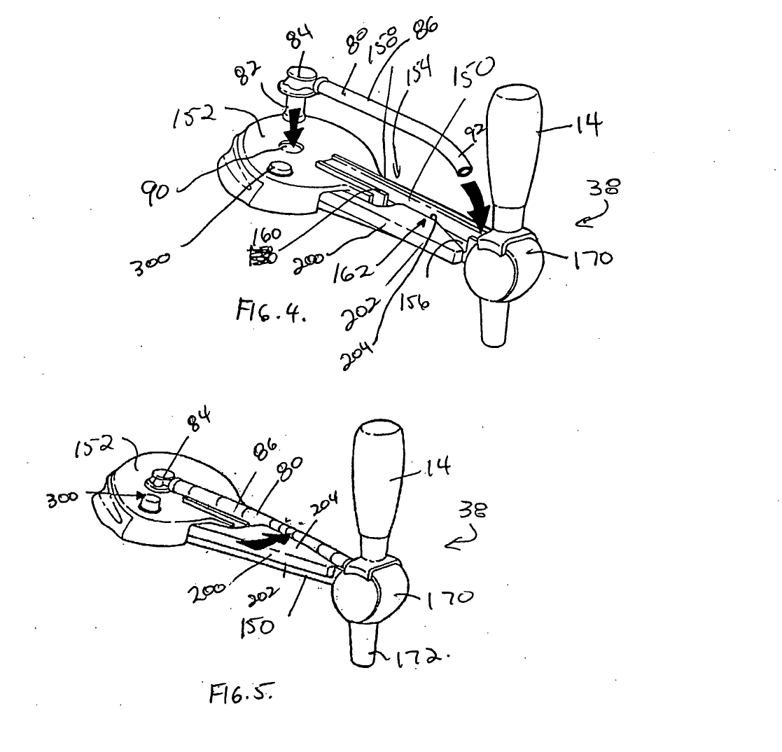

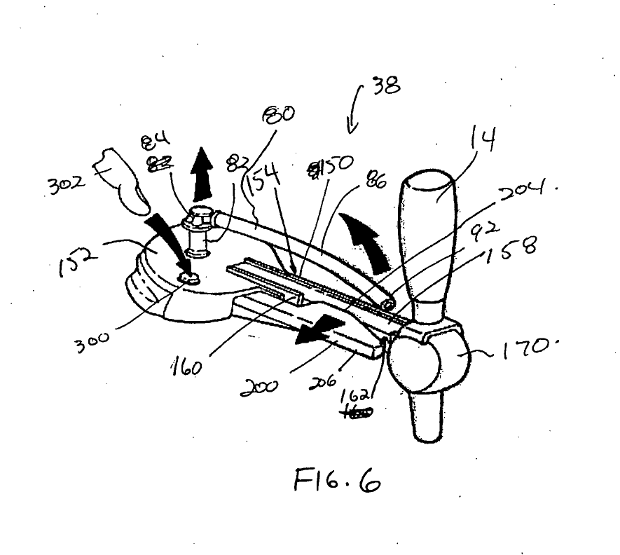

Referring now to FIGS. 3 and 4, the valve assembly 40 and a portion of spear 102 are shown. The valve assembly 40 and spear 102 form part of the beverage dispensing assembly.

The valve assembly 40 is adapted to fit into a raised collar aperture 42 of keg 22. The valve assembly 40 has an annular shaped body 46 that is secured in the aperture 42. The valve body 46 has an annular groove 47 and flange 49 that is adapted to extend above the keg 22 for mating with a tap dispensing adapter 38 (FIG. 4) connected to tap 14.

The valve body 46 has a first passageway 48, a second passageway 50, and a third passageway 52 spaced apart from each other and extending through the valve body 46. As best seen in FIG. 6, the first passageway 48 is centrally disposed or located within the valve body 46 and the second and third passageways 50, and 52 are spaced radially of the first central passageway 48.

The valve assembly includes a first valve 54, a second valve 56 and a third valve 58. The first valve 54 is seated in the first passageway 48 for controlling the flow of the beverage or beer through the first passageway 48 into and out of the bag 44.

The second valve 56 is seated in the second passageway 50 for controlling the flow of gas such as carbon dioxide through the second passageway 50 into and out of the bag 44.

The third valve 58 is seated in the third passageway 52 and controls the flow of gas through the third passageway 52 into and out of the keg 22 exterior to the bag 44.

Referring to FIGS. 4 to 9, the tap adapter 38 of the present invention is shown in more detail. It should be understood that the tap adapter 38 is mounted to the valve assembly 40 in fluid flow communication with the first valve 54. The adapter 38 has a shoulder 152 having a flange (not shown) that is adapted to be snap fitted over valve assembly flange 49 (FIG. 3) and into groove 47.

The tap adapter 38 has a support arm 150 integrally connected with the shoulder 152. The support arm has an elongate channel 154. Channel 154 has a floor 156, a first side wall portion 158 and a second side wall portion 160. An access portion 162 (FIG. 4) is positioned adjacent the second side wall portion 158.

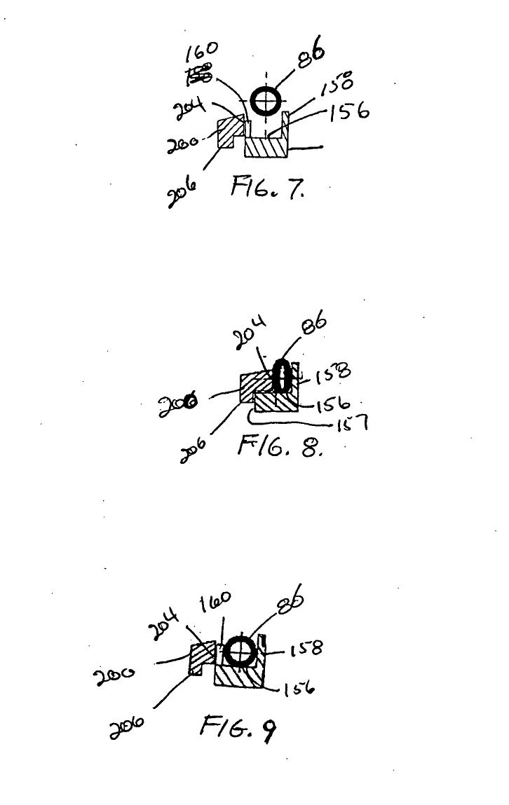

In FIGS. 4 and 7 a dispensing tube 80 is shown in a position where it is about to be inserted into the tap adapter 38. The dispensing tube 80 is shown to have a valve connection end portion 82 connected through a 90 degree elbow connector 84 with a flexible walled portion 86 of the dispensing tube. In this position the flexible wall portion 86 of the dispensing tube has a circular cross section and the connecting end portion 82 is positioned above a central opening or aperture 90 in the shoulder 152.

In FIGS. 5 and 8, the user has pushed the connector 84 of the dispensing tube 80 against the rim of the aperture 90 so that the connecting end 82 of the dispensing tube 80 is in sealing connection with the first valve 54 (FIG. 3) of the valve assembly. This permits for the dispensing of beverage from the keg bag through valve 54 and tube 80.

In FIG. 5, the tube 80 has the flexible wall portion 86 positioned in the channel 154 such that the tube 80 is supported on the floor 156 between the first and second side wall portions 158 and 160. A dispensing end portion 92 of the tube 80 is inserted into a tap end portion 170 of the support arm 150.

Tap handle 14 is pivoted forward to control the flow of beverage from dispense tube end portion 92 and through the spout 172. In the position shown in FIGS. 4 through 6, the tap handle 14 is in the closed position shutting off the flow of beverage through the passageway of the dispensing tube 80.

The tap adapter 38 further includes a flow restricting actuator 200. The flow restricting actuator 200 is mounted in a pivotal manner to the shoulder 152. The flow restricting actuator comprises an elongate lever 202. Lever 202 extends laterally adjacent the support arm 150 and has a protrusion portion 204. The actuator 200 further includes a depending flange 206 that is best seen in FIGS. 7 through 9.

The flow restricting actuator 200 is laterally movable between a first position shown in FIGS. 4 and 7 and a second position shown in FIGS. 5 and 8. As the actuator 200 moves from the position shown in FIG. 4 to the position shown in FIG. 5, the protrusion 204 moves through the access opening 162 of the support arm 150 to squeeze the flexible wall portion 86 of the dispense tube 80 between the first wall portion 158 and the flow restricting actuator protrusion 204. This results in a partial collapse of the flexible wall portion 86 and controls or restricts the flow of beverage through the passageway of the tube 80. The squeezing effect of the actuator 200 is best shown in FIG. 8. The actuator 200 is then movable into an open position or its first position as shown in FIGS. 6 and 9.

In accordance with an aspect of the present invention the shoulder 152 includes a push button switch 300 which is actuable by a human finger 302. In FIG. 4, the push button switch 300 is shown in a depressed position. When the tube end portion 82 is inserted in through aperture 90 of the shoulder 152, push button switch 30 rises to the position shown in FIG. 5. At the same time, the flow restricting actuator 200 moves, or can be moved, inwardly through the access opening 162 to squeeze the flexible wall portion 86 as shown in FIGS. 5 and 8. The movement of the flow restricting actuator 200 is controlled by flange 206 which abuts up against an edge wall 157 of the support arm 150 (see FIG. 8). In this position, the actuator 200 may also be supported by the support arm 150 as the actuator 200 passes over the floor 156 of the support arm 150.

To release the dispensing tube 80 from the valve assembly and to permit the dispensing tube 80 to be removed from the tap adapter 38, a person, represented by the finger shown in FIG. 6, depresses the switch 300 resulting in the end portion 82 of the tube 80 being pushed up through the aperture 90 of the shoulder 152. At the same time, the actuator 200 swings or pivots out from the support arm 150. This results in the resilient dispensing tube 80 expanding to its original shape. Lastly, the dispensing end 92 of the tube 80 is removed from the tap end 170. The tube then can be disposed of and a new tube inserted or alternatively, the tube can be cleaned and reused.

What is claimed is:

1. A tap adapter for use in dispensing an alcohol beverage from a container, the tap adapter comprising:
a shoulder and a support arm, the support arm having an elongate channel having a floor, a first side wall portion and a second side wall portion, and the support arm having an access portion adjacent the second side wall portion;
a dispensing tube supported in the channel on the floor between the first and second side wall portions, the dispensing tube providing a beverage flow passageway for dispensing beverage from the container, and the dispensing tube having at least a flexible wall portion;
a flow restricting actuator pivotally attached to the shoulder and movable between a first position remote of the dispensing tube and a second position at least partially passing through the access portion of the support arm to squeeze the flexible wall portion between the first wall portion and the flow restricting actuator so as to partially collapse the flexible wall portion and restrict flow of beverage through the passageway.

2. The tap adapter of claim 1 wherein the flow restricting actuator comprises an elongate lever that extends adjacent the support arm and has a protrusion that is movable laterally through the access opening of the support arm to engage the flexible wall portion of the dispensing tube.

3. The tap adapter of claim 2 wherein the protrusion is adapted to slide over the floor of the channel and has a depending flange adapted to engage the support arm to limit displacement of the protrusion through the access opening so as to control the partial collapse of the flexible wall portion.

4. The tap adapter of claim 1 wherein the tap adapter has a tap mounted to the support arm at an end portion opposite from the shoulder, the tap having a cam member that rotates to pinch against the tube to close the passageway.

5. The tap adapter of claim 1 wherein the flow restricting actuator is locked when in the second position and wherein the shoulder includes a switch that is actuated by a user to release the flow restricting actuator from the second position.

6. The tap adapter of claim 5 wherein the flow restricting actuator retracts into its first position when the switch is actuated.

7. The tap adapter of claim 1 adapted for use in dispensing an alcohol beverage from a keg containing the alcohol beverage, the keg having a neck and a valve assembly mounted to the neck of the keg, the valve assembly having a first valve through which beverage is dispensed from the keg, the shoulder of the tap adapter being adapted for releasable mounting with the valve assembly, the dispensing tube has a first end portion adapted for sealing connection through the shoulder with the first valve for receiving the beverage, the passageway has a second end portion from which the beverage is dispensed

8. The tap adapter of claim 7 wherein the flow restricting actuator comprises an elongate lever that extends adjacent the support arm and has a protrusion that is laterally movable through the access opening of the support arm to engage the flexible wall portion of the dispensing tube.

9. The tap adapter of claim 8 wherein the protrusion is adapted to slide over the floor of the channel and has a depending flange adapted to engage the support arm to limit displacement of the protrusion through the access opening so as to control the partial collapse of the flexible wall portion.

10. The tap adapter of claim 7 wherein the flow restricting actuator is locked when in the second position and wherein the shoulder includes a switch that is actuated by a user to release the flow restricting actuator from the second position and to disconnect the first end portion of the dispensing tube from the first valve.

11. The tap adapter of claim 10 wherein the flow restricting actuator retracts into its first position when the switch is actuated.

12. A tap adapter for use in dispensing an alcohol beverage from a container, the tap adapter comprising:
a dispensing tube supported by the support arm and providing a beverage flow passageway for dispensing beverage from the container, and the dispensing tube having at least a flexible wall portion;
a flow restricting actuator pivotally attached to the shoulder and movable between a first position remote of the dispensing tube and a second locked position to partially collapse the flexible wall portion and restricting flow of beverage through the passageway; and,
a switch, when actuated by a user, for releasing the flow restricting actuator from the second locked position.

13. The tap adapter of claim 12 wherein the switch is mounted with the shoulder.

14. The tap adapter of claim 12 adapted for use in dispensing an alcohol beverage from a keg containing the alcohol beverage, the keg having a neck and a valve assembly mounted to the neck of the keg, the valve assembly having a first valve through which beverage is dispensed from the keg, the shoulder of the tap adapter being adapted for releasable mounting with the valve assembly, the dispensing tube has a first end portion adapted for sealing connection through the shoulder with the first valve for receiving the beverage, the passageway has a second end portion from which the beverage is dispensed.

15. The tap adapter of claim 14 wherein the switch, when actuated by a user, further disconnects the first end portion of the dispensing tube from a first valve of the keg.

16. The tap adapter of claim 15 wherein the flow restricting actuator retracts into its first position when the switch is actuated.
